(19) United States
(12) Patent Application Publication
(10) Pub. No.: US 2022/0042321 A1
(43) Pub. Date: Feb. 10, 2022

(54) SOLID WOOD COMPOSITE FLOOR BASE MATERIAL HAVING FISHBONE-SHAPED CORE MATERIAL

(71) Applicant: Wuhan Wangrenzhong New Plate Material Investment Management Co., Ltd., Wuhan (CN)

(72) Inventors: Renzhong WANG, Wuhan (CN); Chao WANG, Wuhan (CN)

(21) Appl. No.: 17/509,098

(22) Filed: Oct. 25, 2021

Related U.S. Application Data
(63) Continuation-in-part of application No. PCT/CN2020/084567, filed on Apr. 14, 2020.

(30) Foreign Application Priority Data
Apr. 24, 2019 (CN) 201920567949.8

(51) Int. Cl. E04F 15/04; B32B 21/13; B32B 21/14; B32B 3/14; B32B 5/12; B32B 7/12

(52) U.S. Cl. CPC E04F 15/04; B32B 21/13; B32B 21/14; B32B 3/14; B32B 2471/00; B32B 7/12; B32B 2250/03; B32B 2250/40; B32B 2307/732; B32B 5/12

(57) ABSTRACT

A solid wood composite floor base material includes a central transverse grain core plate, insertion strips on two sides of the central transverse grain core plate, a surface layer, a bottom layer panel, and a longitudinal grain batten. The longitudinal grain batten is embedded in the middle of the central transverse grain core plate in the length direction. The central transverse grain core plate is divided into a left part and a right part by the middle longitudinal grain batten, i.e., a left central transverse grain core plate and a right central transverse grain core plate. The middle longitudinal grain batten, the left central transverse grain core plate and the right central transverse grain core plate form a fishbone-shaped wood grain structure.

### CROSS-REFERENCE TO RELATED APPLICATIONS

This application is a continuation-in-part of International Patent Application No. PCT/CN2020/084567 with an international filing date of Apr. 14, 2020, designating the United States, now pending, and further claims foreign priority benefits to Chinese Patent Application No. 201920567949.8 filed Apr. 24, 2019. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to a solid wood composite floor base material having a fishbone-shaped core material, and belongs to the technical field of decorative materials, and in particular to the technical field of solid wood floors.

At present, solid wood floor is popular with people because of its beauty, environmental protection, luxury and other characteristics. However, the growth period of wood is too long, and the problem of wood shortage is becoming more and more serious, especially precious species are getting scarcer. Common wooden floors are made of single-piece rectangular slats having grooves and tongues on the periphery thereof which are inlaid with each other. The most important thing about the wooden floor is that the very thin surface layer is enjoyed by people, but most part is buried underneath, which leads to a lot of waste and thus does not meet the requirements of a conservation-minded society where resources are rational and fully utilized. In addition, narrow wood cannot be applied to the wooden floor, and the wooden floor has disadvantages such as deformation or cracks due to wood swelling and shrinkage. The base material plates of the plate body of the frame-type solid wood floor comprise a central transverse grain core plate, a bottom layer and insertion strips on the two sides. The central transverse grain core plate between the insertion strips on the two sides is made of narrow wood transversely spliced, thus solving the above problems to a certain extent. However, it is proved in practice that there are other problems such as shrinkage deformation as well as inability to use even narrower wood.

### SUMMARY

An object of the disclosure is to provide a solid wood composite floor base material having a fishbone-shaped core material, which can solve the problems of shrinkage deformation and inability to use even narrower wood to the greatest extent.

To achieve the above object, a solid wood composite floor base material having a fishbone-shaped core material is provided in the disclosure. The solid wood composite floor base material comprises a central transverse grain core plate, insertion strips on two sides of the central transverse grain core plate, a surface layer, a bottom layer panel, and a longitudinal grain batten; wherein the longitudinal grain batten is embedded in a middle of the central transverse grain core plate in a length direction; the central transverse grain core plate is divided into a left part and a right part by the middle longitudinal grain batten, i.e., a left central transverse grain core plate and a right central transverse grain core plate; and the middle longitudinal grain batten, the left central transverse grain core plate and the right central transverse grain core plate form a fishbone-shaped wood grain structure.

In an embodiment of the disclosure, the widths of the left central transverse grain core plate and the right central transverse grain core plate are equal.

In another embodiment of the disclosure, the insertion strips on the two sides are bonded with the left central transverse grain core plate, the right central transverse grain core plate, and the middle longitudinal grain batten.

In still another embodiment of the disclosure, the surface layer and the bottom layer panel are made of wood veneers which are 2-5 mm thick and have rotary-cut transverse wood grains, and the wood veneers are coated and laminated above and below the left central transverse grain core plate, the right central transverse grain core plate, the middle longitudinal grain batten, and the insertion strips on the two sides by means of an adhesive.

The advantages associated with the solid wood composite floor base material having a fishbone-shaped core material of the disclosure are as follows: the base material plates of the disclosure are made of fast-growing wood or conifer, and the base material plates can be made of short and narrow materials (i.e., waste wood), which not only has low overall cost, but also saves precious wood to the utmost extent and achieves the same performance as the precious wood by making full use of fast-growing wood and narrow wood.

The insertion strips on the two sides of the base material plates of the disclosure can be made of finger jointed battens, which are laminated in the longitudinal fiber direction and the transverse fiber direction, thus increasing the compression resistance and the load of the floor, therefore ensuring the stress stability of the whole floor, and concealing the defect of cracks in multiple transverse base material plates in the middle due to shrinkage, and guaranteeing the strength of the tongues and grooves on the two sides as well.

Because a batten with longitudinal grain, which is perpendicular to the wood grain of the central transverse grain core plate, is provided in the middle of the core material of the plate body in the length direction, the wood grain of the core material is fishbone shaped, which enables to decompose the deformation stress of the core material to the maximum extent, and to improve the flexural strength of the plate body. In addition, the central transverse grain core plate can be made of even shorter and narrower materials (i.e., waste wood), hence the problem of inability to use even narrower wood is solved.

The surface layer and/or the bottom layer panel of the disclosure are made of wood veneers which are 2-5 mm thick and have rotary-cut transverse wood grains, and the wood veneers are coated and laminated above and below the left central transverse grain core plate, the right central transverse grain core plate, the middle longitudinal grain batten, and the insertion strips on the two sides by means of an adhesive, which not only ensures a sound stability, but also improves the flexural strength of the plate body.

### BRIEF DESCRIPTION OF THE DRAWINGS

FIG. 1 is a schematic diagram of a solid wood composite floor base material of the disclosure; and

FIG. 2 is a schematic diagram showing the bond between the central transverse grain core plate, the middle longitudinal grain batten and the insertion strips on the two sides.

### DETAILED DESCRIPTIONS

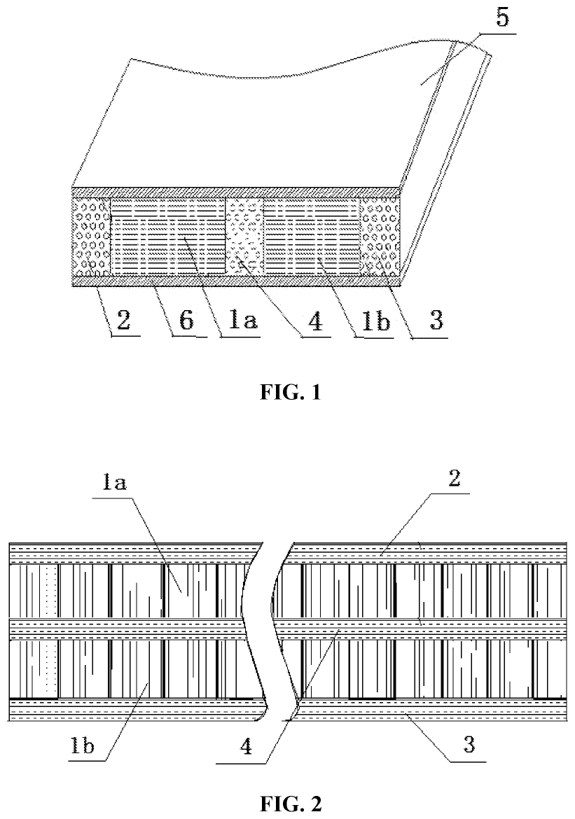

FIG. 1 and FIG. 2 are examples of a solid wood composite floor base material of the disclosure.

A solid wood composite floor base material having a fishbone-shaped core material of the disclosure comprises a central transverse grain core plate 1, insertion strips 2, 3 on the two sides, a surface layer 4, and a bottom layer panel 5. A longitudinal grain batten 6 is embedded in the middle of the central transverse grain core plate 1 in the length direction. The central transverse grain core plate 1 is divided into a left part and a right part by the middle longitudinal grain batten 6, i.e., a left central transverse grain core plate 1a and a right central transverse grain core plate 1b. The middle longitudinal grain batten 6, the left central transverse grain core plate 1a and the right central transverse grain core plate 1b form a fishbone-shaped wood grain structure.

The widths of the left central transverse grain core plate 1a and the right central transverse grain core plate 1b are equal.

The insertion strips 2, 3 on the two sides are bonded with the left central transverse grain core plate 1a, the right central transverse grain core plate 1b, and the middle longitudinal grain batten 6.

The panels of the surface layer 4 and/or the bottom layer panel 5 are made of wood veneers which are 2-5 mm thick and have rotary-cut transverse wood grains, and the wood veneers are coated and laminated above and below the left central transverse grain core plate 1a, the right central transverse grain core plate 1b, the middle longitudinal grain batten 6, and the insertion strips 2, 3 on the two sides by means of an adhesive.

The central transverse grain core plate of the base material plates of the disclosure is made of fast-growing species or coniferous species.

The central transverse grain core plate and the insertion strips (hard batten) on the two sides are connected as a whole by bonding means, such as by adhesive cold pressing (or hot pressing). The surface layer and the bottom layer panel are made of wood veneers which are 2-5 mm thick and have rotary-cut transverse wood grains, and the wood veneers are coated thereon and then bonded by means of an adhesive and finally made into the floor by mechanical processing. The disclosure is also suitable for making floors of various shapes, such as ordinary straight floors or curved floors.

The core of the disclosure is that the longitudinal grain batten is embedded in the middle of the central transverse grain core plate in the length direction, enabling to make the left central transverse grain core plate, the right central transverse grain core plate and the middle longitudinal grain batten form a fishbone-shaped wood grain structure. The disclosure makes full use of fast-growing wood and narrow wood and improves the flexural strength of the plate body. Therefore, any base material or floor with a middle longitudinal grain batten in the length direction belongs to the protection scope of the present disclosure.

What is claimed is:

1. A solid wood composite floor base material, comprising a central transverse grain core plate, insertion strips on two sides of the central transverse grain core plate, a surface layer, a bottom layer panel, and a longitudinal grain batten; wherein the longitudinal grain batten is embedded in a middle of the central transverse grain core plate in a length direction; the central transverse grain core plate is divided into a left part and a right part by the middle longitudinal grain batten, i.e., a left central transverse grain core plate and a right central transverse grain core plate; and the middle longitudinal grain batten, the left central transverse grain core plate and the right central transverse grain core plate form a fishbone-shaped wood grain structure.

2. The solid wood composite floor base material of claim 1, wherein widths of the left central transverse grain core plate and the right central transverse grain core plate are equal.

3. The solid wood composite floor base material of claim 1, wherein the surface layer and the bottom layer panel are made of wood veneers which are 2-5 mm thick and have rotary-cut transverse wood grains, and the wood veneers are coated and laminated above and below the left central transverse grain core plate, the right central transverse grain core plate, the middle longitudinal grain batten, and the insertion strips on the two sides by means of an adhesive.

4. The solid wood composite floor base material of claim 2, wherein the surface layer and the bottom layer panel are made of wood veneers which are 2-5 mm thick and have rotary-cut transverse wood grains, and the wood veneers are coated and laminated above and below the left central transverse grain core plate, the right central transverse grain core plate, the middle longitudinal grain batten, and the insertion strips on the two sides by means of an adhesive.
